(19) United States
(12) Patent Application Publication
(10) Pub. No.: US 2020/0407261 A1
(43) Pub. Date: Dec. 31, 2020

(54) GLASS SEPARATION SYSTEMS AND GLASS MANUFACTURING APPARATUSES COMPRISING THE SAME

(71) Applicant: Corning Incorporated, Corning, NY (US)

(72) Inventors: Tai Hsin Chang, Taichung City (TW); Kun Chih Chen, Taichung City (TW); Ying Hao Chen, Taichung City (TW); Charles Robert Rumsey, Savona, NY (US)

(21) Appl. No.: 16/969,753

(22) PCT Filed: Feb. 5, 2019
(86) PCT No.: PCT/US2019/016655

§ 371 Date: Aug. 13, 2020

Related U.S. Application Data
(60) Provisional application No. 62/629,829, filed on Feb. 13, 2018.

(51) Int. Cl. C03B 33/02; C03B 33/033; C03B 33/023

(52) U.S. Cl. CPC C03B 33/0215; C03B 33/0235; C03B 33/033

(57) ABSTRACT

Glass separation systems for separating glass substrates from a continuous glass ribbon are disclosed. In one embodiment, the system may include an A-surface nosing bar positioned on a first side of a glass conveyance pathway. A long axis of the A-surface nosing bar may be substantially orthogonal to a conveyance direction of the glass conveyance pathway. The glass separation system may further comprise a B-surface nosing bar positioned on a second side of the glass conveyance pathway and opposite the A-surface nosing bar. A long axis of the B-surface nosing bar may be substantially orthogonal to the conveyance direction of the glass conveyance pathway. The A-surface nosing bar and the B-surface nosing bar may be pivotable about axes of rotation parallel to the conveyance direction of the glass conveyance pathway.

### CROSS-REFERENCE TO RELATED APPLICATION

This application claims the benefit of priority under 35 U.S.C. § 119 of U.S. Provisional Application Ser. No. 62/629,829 filed on Feb. 13, 2018, the content of which is relied upon and incorporated herein by reference in its entirety.

### BACKGROUND

### Field

The present specification generally relates to systems for separating glass sheets from glass ribbons and glass manufacturing apparatuses comprising the same.

### Technical Background

Continuous glass ribbons may be formed by processes such as the fusion draw process or other, similar downdraw processes. The fusion draw process yields continuous glass ribbons which have surfaces with superior flatness and smoothness when compared to glass ribbons produced by other methods. Individual glass sheets sectioned from continuous glass ribbons formed by the fusion draw process can be used in a variety of devices including flat panel displays, touch sensors, photovoltaic devices and other electronic applications.

Various techniques for separating discrete glass sheets from a continuous glass ribbon may be used. These techniques generally including clamping a portion of the continuous glass ribbon while the ribbon is scored and a discrete glass sheet is separated from the continuous glass ribbon by applying a bending moment about the score line.

While such techniques are effective for separating a discrete glass sheet from a continuous glass ribbon, a need exists for alternative apparatuses for separating discrete glass sheets from continuous glass ribbons.

### SUMMARY

According to one embodiment, a glass separation system for separating a glass substrate from a continuous glass ribbon may include an A-surface nosing bar positioned on a first side of a glass conveyance pathway. A long axis of the A-surface nosing bar may be substantially orthogonal to a conveyance direction of the glass conveyance pathway. The A-surface nosing bar may be pivotable about an axis of rotation parallel to the conveyance direction of the glass conveyance pathway. The glass separation system may further comprise a B-surface nosing bar positioned on a second side of the glass conveyance pathway and opposite the A-surface nosing bar. A long axis of the B-surface nosing bar may be substantially orthogonal to the conveyance direction of the glass conveyance pathway. The B-surface nosing bar may be pivotable about an axis of rotation parallel to the conveyance direction of the glass conveyance pathway.

According to another embodiment, an apparatus for forming a glass substrate from a glass ribbon may comprise a forming vessel, a glass conveyance pathway, a glass separation system, and a scoring apparatus. The forming vessel may include a first forming surface and a second forming surface converging at a root. The glass conveyance pathway may extend from the root in a downward vertical direction. The glass separation system may be positioned downstream of the forming vessel and may include an A-surface nosing bar and a B-surface nosing bar. The A-surface nosing bar may be positioned on a first side of the glass conveyance pathway and include a first A-surface nosing actuator coupled to a first end of the A-surface nosing bar and a second A-surface nosing actuator coupled to a second end of the A-surface nosing bar. The B-surface nosing bar may be positioned on a second side of the glass conveyance pathway opposite the A-surface nosing bar and may include a first B-surface nosing actuator coupled to a first end of the B-surface nosing bar, and a second B-surface nosing actuator coupled to a second end of the B-surface nosing bar. The scoring apparatus may be positioned on a first side of the glass conveyance pathway downstream from the A-surface nosing bar. The first end of the A-surface nosing bar may be opposite the first end of the B-surface nosing bar and the second end of the A-surface nosing bar may be opposite the second end of the B-surface nosing bar. The glass separation system may include a clamping mode and an adjustment mode wherein, in the adjustment mode, an actuation stroke length of the first A-surface nosing actuator and an actuation stroke length of the second A-surface nosing actuator are independent of one another and an actuation stroke length of the first B-surface nosing actuator and an actuation stroke length of the second B-surface nosing actuator are independent of one another.

According to another embodiment, a method of separating a glass sheet from a glass ribbon may include conveying a continuous glass ribbon in a conveyance direction on a glass conveyance pathway. The glass conveyance pathway may extend through a glass separation system comprising an A-surface nosing bar positioned on a first side of the glass conveyance pathway and a B-surface nosing bar positioned on a second side of the glass conveyance pathway. The method may further include pivoting the A-surface nosing bar about an A-surface axis of rotation and pivoting the B-surface nosing bar about a B-surface axis of rotation. After the pivoting, the A-surface nosing bar and the B-surface nosing bar may be parallel with the major surfaces of the continuous glass ribbon. Thereafter, the A-surface nosing bar and the B-surface nosing bar may be advanced towards the continuous glass ribbon such that the continuous glass ribbon is clamped between the A-surface nosing bar and the B-surface nosing bar. A score line may then be formed in the continuous glass ribbon and a glass sheet may be separated from the continuous glass ribbon at the score line.

Additional features and advantages of the glass separation systems described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts one embodiment of a glass forming apparatus according to one or more embodiments described herein;

FIG. 2A schematically depicts a continuous glass ribbon positioned between the A-surface nosing bar and the B-surface nosing bar of an illustrative glass separation system;

FIG. 2B schematically depicts the reorientation of the A-surface nosing bar and the B-surface nosing bar of the glass separation system of FIG. 2A such that the A-surface nosing bar and the B-surface nosing bar are parallel with one another and the continuous glass ribbon;

FIG. 3 schematically depicts a top view of a glass separation system according to one or more embodiments described herein;

FIG. 4 schematically depicts a cross section of the glass separation system of FIG. 3;

FIG. 5 schematically depicts a nosing bar actuator of the glass separation system of FIGS. 3 and 4 according to one or more embodiments described herein;

FIG. 6 is a block diagram depicting a controller of the glass separation system and the interconnectivity of various components of the glass separation system with the controller according to one or more embodiments described herein;

FIG. 7 schematically depicts a cross section of the glass separation system with a glass carrier affixed to a portion of the continuous glass ribbon prior to separating a glass sheet from the continuous glass ribbon; and

FIG. 8 schematically depicts a cross section of the glass separation system as a glass sheet is separated from the continuous glass ribbon with the glass carrier.

### DETAILED DESCRIPTION

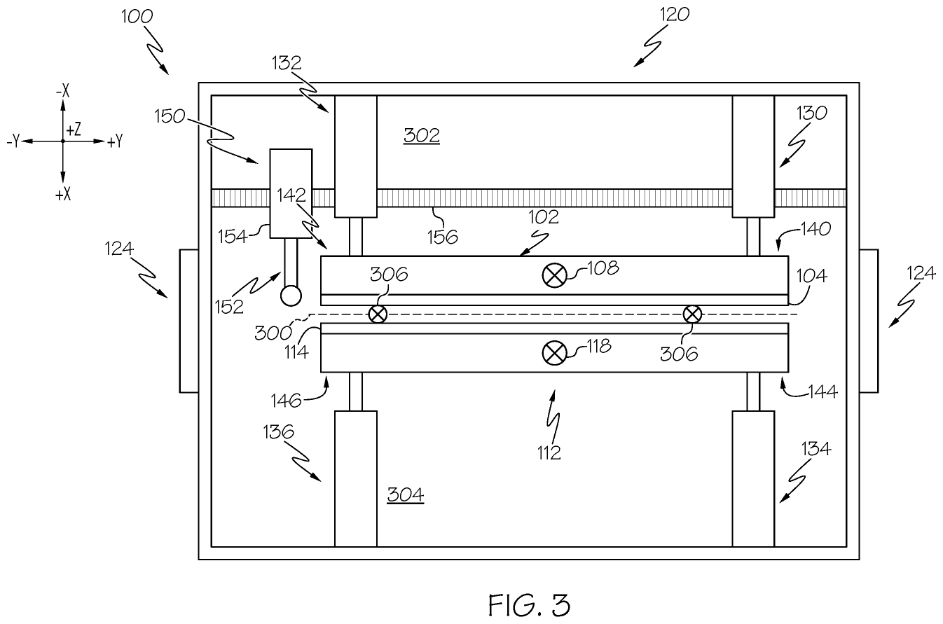

Reference will now be made in detail to various embodiments of glass separation systems, examples of which are illustrated in the accompanying drawings. Whenever possible, the same reference numerals will be used throughout the drawings to refer to the same or like parts. One embodiment of a glass separation system is schematically depicted in FIG. 3, and is designated generally throughout by the reference numeral 100. The glass separation system generally an A-surface nosing bar positioned on a first side of a glass conveyance pathway. A long axis of the A-surface nosing bar may be substantially orthogonal to a conveyance direction of the glass conveyance pathway. The A-surface nosing bar may be pivotable about an axis of rotation parallel to the conveyance direction of the glass conveyance pathway. The glass separation system may further include a B-surface nosing bar positioned on a second side of the glass conveyance pathway and opposite the A-surface nosing bar. A long axis of the B-surface nosing bar may be substantially orthogonal to the conveyance direction of the glass conveyance pathway. The B-surface nosing bar may be pivotable about an axis of rotation parallel to the conveyance direction of the glass conveyance pathway. Various embodiments of glass separation systems and glass manufacturing apparatuses comprising the foregoing nosing bars will be described in further detail herein with specific reference to the appended drawings.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

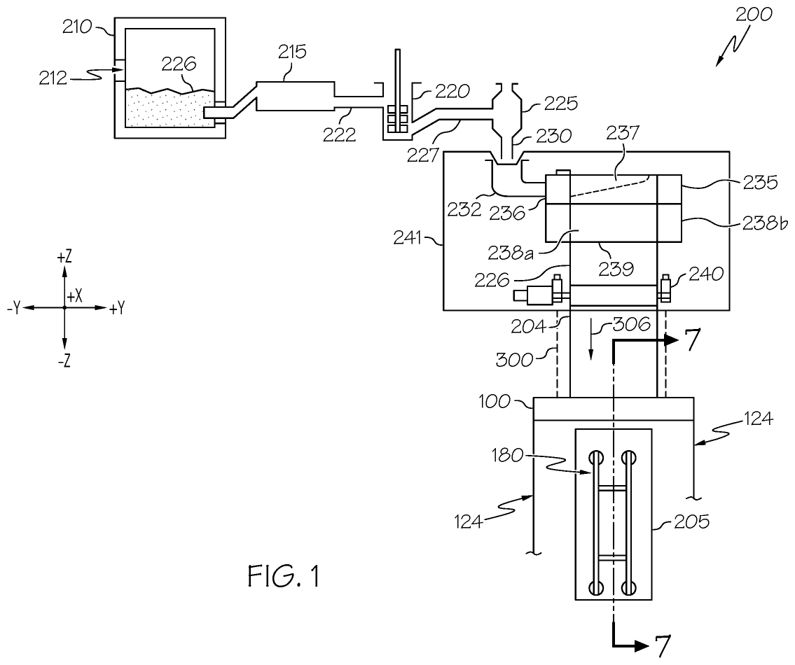

Referring now to FIG. 1, one embodiment of an illustrative glass manufacturing apparatus 200 for forming a continuous glass ribbon 204 is schematically depicted. The glass manufacturing apparatus 200 includes a melting vessel 210, a fining vessel 215, a mixing vessel 220, a delivery vessel 225, a forming apparatus 241 and a glass separation system 100. Glass batch materials are introduced into the melting vessel 210 as indicated by arrow 212. The batch materials are melted to form molten glass 226. The fining vessel 215 receives the molten glass 226 from the melting vessel 210 and removes gas entrained in the molten glass (i.e., bubbles) from the molten glass 226. The fining vessel 215 is fluidly coupled to the mixing vessel 220 by a connecting tube 222. The mixing vessel 220 is, in turn, fluidly coupled to the delivery vessel 225 by a connecting tube 227.

The delivery vessel 225 supplies the molten glass 226 to the forming apparatus 241 through a downcomer 230. The forming apparatus 241 comprises an inlet 232, a forming vessel 235, and a pull roll assembly 240. In the embodiment depicted in FIG. 1, the forming vessel 235 is depicted and described as a fusion forming vessel. However, it should be understood that other embodiments of forming vessels for forming continuous glass ribbons by down-draw methods are contemplated and possible including, without limitation, slot-draw forming vessels. As shown in FIG. 1, the molten glass 226 from the downcomer 230 flows into an inlet 232 which leads to the forming vessel 235. The forming vessel 235 includes an opening 236 that receives the molten glass 226. The molten glass 226 flows into a trough 237 of the forming vessel 235 and then overflows and runs down two sides 238a and 238b of the forming vessel 235 before fusing together at a root 239 of the forming vessel 235. The root 239 is defined by the intersection of the two sides 238a and 238b and is the location where the two streams of molten glass 226 join (e.g., fuse) before being drawn downward by the pull roll assembly 240 to form the continuous glass ribbon 204. The continuous glass ribbon is drawn along a glass conveyance pathway 300 that extends from the root 239 of the forming vessel 235 in a downward direction (e.g., the −Z direction of the coordinate axes depicted in the figures) and through the glass separation system 100.

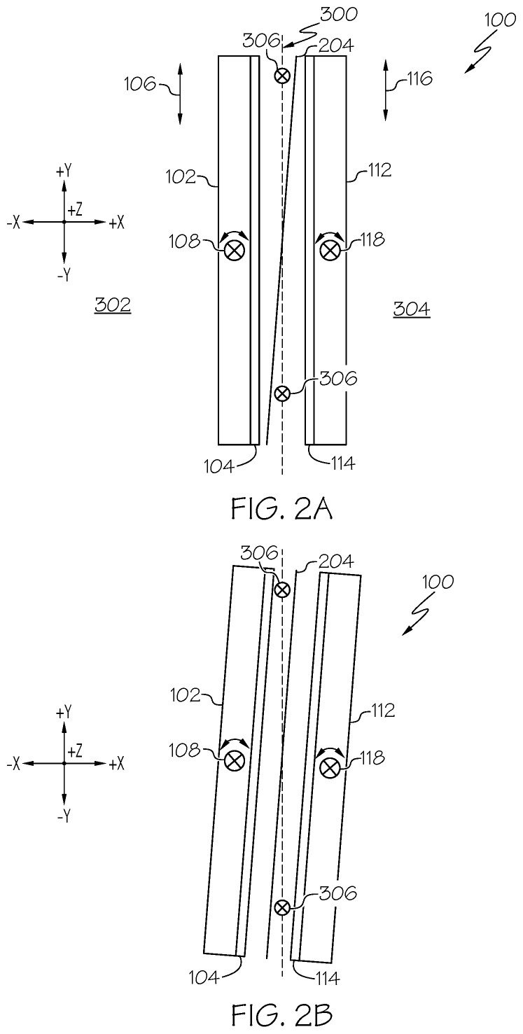

As the continuous glass ribbon 204 is drawn along the glass conveyance pathway 300 and into the glass separation system 100, the continuous glass ribbon 204 may rotate or twist such that the continuous glass ribbon 204 is no longer within or even parallel to the plane of the glass conveyance pathway 300 as it enters the glass separation system 100. This condition is schematically depicted in FIG. 2A. When the continuous glass ribbon 204 deviates from the glass conveyance pathway 300, there is a risk that an edge of the continuous glass ribbon 204 may contact one or more components of the glass separation system 100 which, in turn, may damage the continuous glass ribbon 204 or even result in an uncontrolled fracture and separation of the continuous glass ribbon 204. Alternatively or additionally, when the continuous glass ribbon 204 deviates from the glass conveyance pathway 300, the nosing bars of the glass separation system 100 (described in further detail herein) may be non-parallel with the continuous glass ribbon 204. This may cause unwanted motion in the continuous glass ribbon 204 as the nosing bars of the glass separation system 100 contact the continuous glass ribbon 204 while separating a glass sheet from the continuous glass ribbon 204. This unwanted motion may propagate through the continuous glass ribbon 204, potentially disrupting the glass forming process or even resulting in an uncontrolled fracture and unintended separation of the continuous glass ribbon 204, disrupting the manufacturing process. The glass separation system 100 mitigates the aforementioned problems by including nosing bars which can be reoriented relative to the continuous glass ribbon 204 to account for the twist in the continuous glass ribbon 204 as it is drawn in the conveyance direction of the glass conveyance pathway 300.

Specifically referring to FIG. 2A, one embodiment of a portion of a glass separation system 100 is schematically depicted. The glass separation system 100 generally comprises an A-surface nosing bar 102 and a B-surface nosing bar 112 situated on opposite sides 302, 304 of a glass conveyance pathway 300 (i.e., adjacent the first side 302 and the second side 304 of the glass conveyance pathway). The terms “first side” and “second side” are used herein to refer to the position or orientation of an object or component relative to the glass conveyance pathway. Specifically, the plane of the glass conveyance pathway bisects free space into two parts and the “first side” and the “second side” refer to each part of the bisected free space, respectively. The terms “A-surface” and “B-surface” are used to describe the major surfaces of the glass ribbon which the respective nosing bars contact. Specifically, the A-surface refers to the side of the glass ribbon (or subsequent glass sheet) on which electronic devises (e.g., thin film transistors) are typically deposited and the B-surface is opposite and parallel to the A-surface. Given the utility of the A-surface, contact with the A-surface is usually minimized to avoid defects which may disrupt the operation of the thin film transistors subsequently deposited thereon.

The glass conveyance pathway 300 comprises a conveyance direction 306 which, in the embodiment shown in FIG. 2A, is in the −Z direction of the coordinate axes depicted in the drawing. The −Z direction corresponds to the downward vertical direction. The conveyance direction 306 is the direction that the continuous glass ribbon 204 is drawn from the root 239 of the forming vessel 235 of the glass manufacturing apparatus 200. The continuous glass ribbon 204 is then conveyed along the glass conveyance pathway 300 through the glass separation system 100.

The A-surface nosing bar 102 is positioned on a first side 302 of the glass conveyance pathway 300 and generally comprises an A-surface nosing member 104 positioned adjacent to the glass conveyance pathway 300. A long axis 106 (indicated by a double arrow showing the direction of the long axis 106) of the A-surface nosing bar 102 is substantially orthogonal to the conveyance direction 306 of the glass conveyance pathway 300. That is, the long axis 106 of the A-surface nosing bar 102 is generally transverse to the conveyance direction 306 of the glass conveyance pathway 300. In the embodiments described herein, the A-surface nosing bar 102 is pivotable about an A-surface axis of rotation 108 that is substantially parallel to the conveyance direction 306 of the glass conveyance pathway 300. That is, the A-surface nosing bar 102 is pivotable about a substantially vertical axis of rotation such that an orientation of the A-surface nosing bar 102 can be adjusted in a horizontal plane (i.e., the X-Y plane in the coordinate axes depicted in FIG. 2B). In embodiments, the axis of rotation 108 is positioned at the center of the A-surface nosing bar 102 in the length-wise direction (i.e., the direction of the long axis 106). However, it should be understood that other positions are contemplated and possible.

Similarly, the B-surface nosing bar 112 is positioned on a second side 304 of the glass conveyance pathway 300 opposite the A-surface nosing bar 102 and generally comprises a B-surface nosing member 114 positioned adjacent to the glass conveyance pathway 300. A long axis 116 (indicated by double arrow showing the direction of the long axis 116) of the B-surface nosing bar 112 is substantially orthogonal to the conveyance direction 306 of the glass conveyance pathway 300. That is, the long axis 116 of the B-surface nosing bar 112 is generally transverse to the conveyance direction 306 of the glass conveyance pathway 300. In the embodiments described herein, the B-surface nosing bar 112 is pivotable about a B-surface axis of rotation 118 that is substantially parallel to the conveyance direction 306 of the glass conveyance pathway 300. That is, the B-surface nosing bar 112 is pivotable about a substantially vertical axis of rotation such that an orientation of the B-surface nosing bar 112 can be adjusted in a horizontal plane (i.e., the X-Y plane in the coordinate axes depicted in FIG. 2B). In embodiments, the axis of rotation 118 is positioned at the center of the B-surface nosing bar 112 in the length-wise direction (i.e., the direction of the long axis 116). However, it should be understood that other positions are contemplated and possible.

The A-surface nosing bar 102 and the B-surface nosing bar 112 may be used to apply a clamping force to a continuous glass ribbon 204 drawn along the glass conveyance pathway 300 to facilitate securing the continuous glass ribbon 204 as the continuous glass ribbon 204 is scored in a direction transverse to the conveyance direction 306 and a discrete glass sheet is separated from the continuous glass ribbon 204. To facilitate application of the clamping force, the A-surface nosing bar 102 and the B-surface nosing bar 112 may be further coupled to actuators (not depicted in FIG. 2A) which advance the A-surface nosing bar 102 and the B-surface nosing bar 112 toward and away from one another (i.e., toward and away from the glass conveyance pathway 300), thereby clamping and releasing the continuous glass ribbon 204 as it is conveyed along the glass conveyance pathway 300 in the conveyance direction 306.

In the embodiments described herein, the A-surface nosing bar 102 and the B-surface nosing bar 112 are positioned to apply a clamping force to the continuous glass ribbon 204 upstream (i.e., in +Z direction of the coordinate axes depicted in the drawings) of the location at which the continuous glass ribbon 204 is scored. Clamping the continuous glass ribbon 204 upstream of the scoring location assists in mitigating the upstream propagation of mechanical vibrations introduced into the continuous glass ribbon 204 during the scoring and separating operation. In turn, the mitigation of the upstream propagation of mechanical vibrations mitigates the disruption of the process of forming the continuous glass ribbon 204 with the forming vessel 235 (FIG. 1).

When the A-surface nosing bar 102 and the B-surface nosing bar 112 apply a clamping force to the continuous glass ribbon 204, the continuous glass ribbon 204 is clamped between the A-surface nosing member 104 of the A-surface nosing bar 102 and the B-surface nosing member 114 of the B-surface nosing bar 112. As the A-surface nosing member 104 and the B-surface nosing member 114 directly contact the surface of the continuous glass ribbon 204, the A-surface nosing member and the B-surface nosing member are generally formed from materials which will not damage the surface of the continuous glass ribbon 204 when the clamping force is applied. In some embodiments, the A-surface nosing member 104 and the B-surface nosing member 114 are formed from polymeric materials, such as thermoplastics, thermosets, or thermoplastic elastomers, that have a Shore A durometer hardness from greater than or equal to about 50 to less than or equal to about 70. One non-limiting example of a suitable material from which the A-surface nosing member 104 and the B-surface nosing member 114 may be formed is silicone having a hardness from greater than or equal to about 50 to less than or equal to about 70 on the Shore A durometer scale. However, it should be understood that other materials are contemplated and possible.

As noted hereinabove, the A-surface nosing bar 102 and the B-surface nosing bar 112 are pivotable about respective A-surface and B-surface axes of rotation 108, 118 that are parallel to the conveyance direction 306 of the glass conveyance pathway 300. This facilitates adjusting the orientation of each of the A-surface nosing bar 102 and the B-surface nosing bar 112 to maintain a parallel relationship between the surfaces of the continuous glass ribbon 204 and the A-surface nosing bar 102 and the B-surface nosing bar 112, thereby mitigating the potential for damage to the continuous glass ribbon 204 as it is conveyed in the conveyance direction 306.

For example, FIG. 2A depicts a glass conveyance pathway 300 that is generally parallel to the Y-Z plane of the coordinate axes depicted in the figure and that extends between the A-surface nosing bar 102 and the B-surface nosing bar 112. FIG. 2A also depicts a continuous glass ribbon 204 being drawn in the conveyance direction 306. However, as depicted in FIG. 2A, the continuous glass ribbon 204 has deviated from planarity with the glass conveyance pathway 300. That is, the continuous glass ribbon 204 has twisted slightly about a vertical axis (i.e., an axis that is parallel to the +/−Z axis of the coordinate axes depicted in FIG. 2A) such that only a portion of the continuous glass ribbon is in the plane of the glass conveyance pathway 300. As noted herein, when the continuous glass ribbon 204 deviates from the glass conveyance pathway 300, there is a risk that an edge of the continuous glass ribbon 204 may contact one or more components of the glass separation system 100 which, in turn, may damage the continuous glass ribbon 204 or even result in an uncontrolled fracture of the continuous glass ribbon 204. Alternatively or additionally, when the continuous glass ribbon 204 deviates from the glass conveyance pathway 300, the nosing bars of the glass separation system 100 (described in further detail herein) may be non-parallel with the continuous glass ribbon 204. This may cause unwanted motion in the continuous glass ribbon 204 as the nosing members 104, 114 of the glass separation system 100 contact the continuous glass ribbon 204 while separating a sheet from the glass ribbon. This unwanted motion may propagate through the continuous glass ribbon 204, potentially disrupting the glass forming process or even result in an uncontrolled fracture of the continuous glass ribbon 204.

Referring now to FIGS. 2A and 2B, in the embodiments described herein, deviations of the continuous glass ribbon 204 from planarity with the glass conveyance pathway 300 may be accounted for by pivoting the A-surface nosing bar 102 about the A-surface axis of rotation 108 and pivoting the B-surface nosing bar 112 about the B-surface axis of rotation 118 such that the A-surface nosing bar 102 and the B-surface nosing bar 112 are parallel with the continuous glass ribbon 204. This mitigates the risk of an edge of the continuous glass ribbon 204 contacting one or more components of the glass separation system 100 due to the A-surface nosing bar 102 and the B-surface nosing bar 112 being non-parallel with the glass ribbon 204. This also mitigates the risk of the A-surface nosing bar 102 and the B-surface nosing bar 112 imparting motion to the continuous glass ribbon 204 as a clamping force is applied to the continuous glass ribbon with the A-surface nosing bar 102 and the B-surface nosing bar 112.

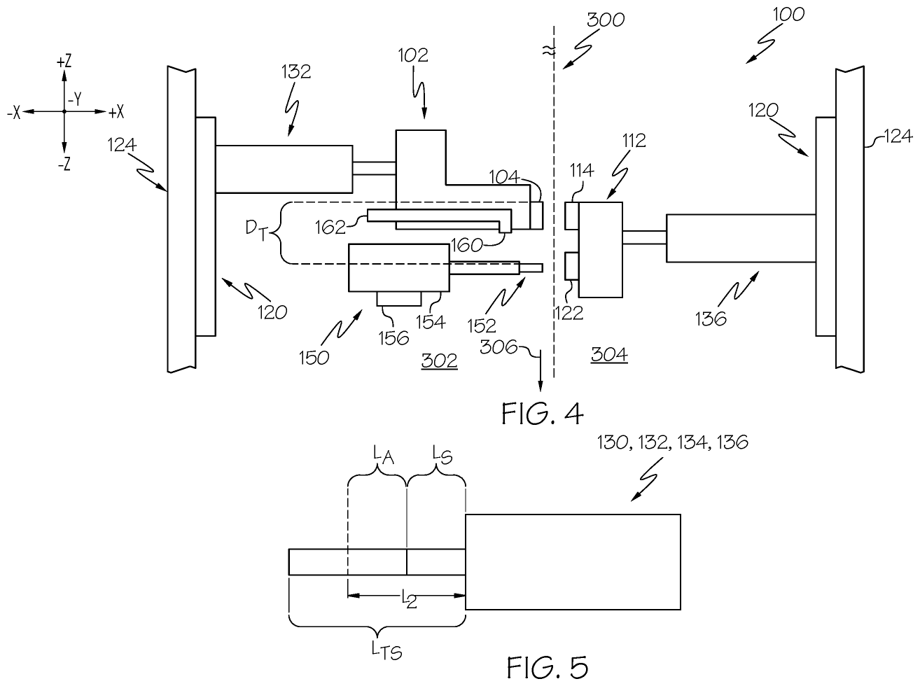

Referring now to FIGS. 3 and 4, FIG. 3 schematically depicts a top view of one embodiment of a glass separation system 100 and FIG. 4 schematically depicts a side cross sectional view of the glass separation system 100. The glass separation system 100 generally includes an A-surface nosing bar 102 and a B-surface nosing bar 112 positioned on opposite sides 302, 304 of a glass conveyance pathway 300, as described herein with respect to FIG. 2A. In the embodiment of the glass separation system 100 depicted in FIG. 3, the A-surface nosing bar 102 and the B-surface nosing bar 112 are supported in a carriage frame 120. In particular, a first A-surface nosing actuator 130 couples the A-surface nosing bar 102 to the carriage frame 120 at a first end 140 of the A-surface nosing bar 102 and a second A-surface nosing actuator 132 couples the A-surface nosing bar 102 to the carriage frame 120 at a second end 142 of the A-surface nosing bar 102. The first and second ends 140, 142 of the A-surface nosing bar 102 are spaced apart in the direction of the long-axis of the A-surface nosing bar 102. Similarly, a first B-surface nosing actuator 134 couples the B-surface nosing bar 112 to the carriage frame 120 at a first end 144 of the B-surface nosing bar 112 and a second B-surface nosing actuator 136 couples the B-surface nosing bar 112 to the carriage frame 120 at a second end 146 of the B-surface nosing bar 112. The first and second ends 144, 146 of the B-surface nosing bar 112 are spaced apart in the direction of the long-axis of the B-surface nosing bar 112. The nosing actuators 130, 132, 134, 136 facilitate advancing the A-surface nosing bar 102 and the B-surface nosing bar 112 toward and away from one another (i.e., toward and away from the glass conveyance pathway 300), thereby clamping and releasing a continuous glass ribbon 204 as it is conveyed along the glass conveyance pathway 300 in the conveyance direction 306. In addition, the nosing actuators 130, 132, 134, 136 facilitate pivoting the A-surface nosing bar 102 and the B-surface nosing bar 112 about respective A-surface and B-surface axes of rotation 108, 118 such that the orientation of the A-surface nosing bar 102 and the B-surface nosing bar 112 can be adjusted relative to a continuous glass ribbon conveyed in the conveyance direction of the glass conveyance pathway 300. In embodiments, the nosing actuators may comprise, for example and without limitation, electro-mechanical actuators such as linear actuators and/or servo motors, hydraulic actuators, pneumatic actuators, or the like.

In embodiments, the glass separation system 100 may further comprise a scoring apparatus 150. In the embodiments described herein, the scoring apparatus 150 is positioned on a first side 302 of the glass conveyance pathway 300 (i.e., on the same side of the glass conveyance pathway 300 as the A-surface nosing bar 102) downstream of the A-surface nosing bar 102 (i.e., in the −Z direction relative to the A-surface nosing bar 102) such that the A-surface nosing bar 102 and the B-surface nosing bar 112 can apply a clamping force to the continuous glass ribbon 204 upstream of the scoring apparatus 150. The scoring apparatus 150 may generally comprise a scoring head 152, a scoring actuator 154, and a rail 156.

The rail 156 may be coupled to the carriage frame 120 and generally extends transverse to the conveyance direction 306 of the glass conveyance pathway 300. In embodiments, the scoring apparatus 150 is mounted on the rail 156 with the scoring actuator 154 which facilitates traversing the scoring apparatus 150 along the length of the rail 156.

In the embodiments described herein, the scoring head 152 is also mounted to the scoring actuator 154 as depicted in FIGS. 4 and 5. In addition to traversing the scoring head 152 along the rail 156, the scoring actuator 154 also extends and retracts the scoring head 152 relative to the glass conveyance pathway 300 (i.e., in the +/−X direction of the coordinate axes depicted in the figures) to facilitate forming a score line in a continuous glass ribbon 204 drawn in the conveyance direction 306 of the glass conveyance pathway 300. The scoring head 152 may comprise, for example, a scoring wheel, a scribing point, or a laser. In one particular embodiment, the scoring head 152 is a scoring wheel. The scoring head 152 and/or scoring actuator 154 may further include, for example, a pressure sensor that measures the pressure exerted on the glass by the scoring head 152. A controller associated with the scoring apparatus 150 may utilize the signal from the pressure sensor and adjust the actuation of the scoring actuator 154 such that a constant pressure and, hence, a constant scoring force is applied to the glass ribbon by the scoring head 152 as the scoring head 152 traverses the glass ribbon in a width-wise direction (i.e., the +/−Y direction of the coordinate axes depicted).

In embodiments where the glass separation system 100 comprises a scoring apparatus 150, the B-surface nosing bar 112 further comprises an anvil nosing 122 positioned opposite the scoring head 152 of the scoring apparatus 150. That is, the anvil nosing 122 is positioned downstream of the B-surface nosing member 114 of the B-surface nosing bar 112. The anvil nosing 122 provides a support surface against which the continuous glass ribbon 204 is pressed during a scoring operation to facilitate formation of a score line and to prevent the scoring head 152 of the scoring apparatus 150 from piercing or breaking the continuous glass ribbon 204. In embodiments the anvil nosing 122 may be made from the same material as the A-surface nosing member 104 and the B-surface nosing member 114. That is, the anvil nosing 122 may be formed from polymeric materials, such as thermoplastics, thermosets, or thermoplastic elastomers which have a Shore A durometer hardness from greater than or equal to about 50 to less than or equal to about 70. One non-limiting example of a suitable material from which the anvil nosing 122 may be formed is silicone having a Shore A durometer hardness from greater than or equal to about 50 to less than or equal to about 70. However, it should be understood that other materials are contemplated and possible. In embodiments, the Shore A durometer hardness of the anvil nosing 122 may be greater than the Shore A durometer hardness of either the A-surface nosing member 104 or the B-surface nosing member 114.

In embodiments, the vertical distance between the upper most portion of the A-surface nosing member 104 that contacts the continuous glass ribbon 204 and the line of intersection between the scoring head 152 and the glass conveyance pathway 300 (referred to herein and illustrated FIG. 4 as the “trim distance D_{L}”) may be less than 25 mm, such as less than or equal to 20 mm, less than or equal to 18 mm, or even less than or equal to 15 mm. Minimizing the trim distance D_{L} reduces the amount of glass that is subject to mechanical contact during the glass drawing operation and, as a result, reduces the amount of glass which is trimmed from a glass sheet after the sheet is separated from the glass ribbon (i.e., minimizing the trim distance minimizes waste glass and maximizes the useable area of a glass sheet separated from the continuous glass ribbon).

In embodiments, described herein the A-surface nosing bar 102 may further comprise at least one vacuum port 160 coupled to a vacuum line 162. The vacuum line 162 may be coupled to a vacuum pump (not depicted) which supplies a negative pressure to the vacuum line 162 and the at least one vacuum port 160. The vacuum port 160 may be positioned downstream of the of the A-surface nosing member 104 and upstream of the scoring apparatus 150. In the embodiment illustrated in FIG. 4, the vacuum port 160 is oriented and directed towards the scoring apparatus 150 such that any glass particulates and/or other debris generated during formation of a score line in a continuous glass ribbon 204 and/or during separation of a glass sheet from a continuous glass ribbon 204 is collected into the vacuum port 160 and evacuated from the glass separation system 100 through the vacuum line 162. Evacuation of glass particulates and/or other debris from glass scoring and glass separation mitigates the risk that the glass particle and/or debris will cause defects or other damage to the continuous glass ribbon and/or glass sheets separated from the continuous glass ribbon. In embodiments, the vacuum port extends along the length of the nosing member so that debris is collected throughout the stroke length of the scoring member in the width-wise direction of the glass ribbon.

Still referring to FIGS. 3 and 4, in embodiments the glass separation system 100 is moveable in (and counter to) the conveyance direction 306 of the glass conveyance pathway 300. Specifically, the carriage frame 120 may be affixed to rails 124 with actuators (not shown), such as motors or the like, which facilitate traversing the carriage frame 120, and hence the glass separation system 100, relative to the glass conveyance pathway 300. This permits the glass separation system 100 to be positioned and repositioned relative to the continuous glass ribbon 204 and thereby separate discrete glass sheets having a desired dimension from the continuous glass ribbon 204.

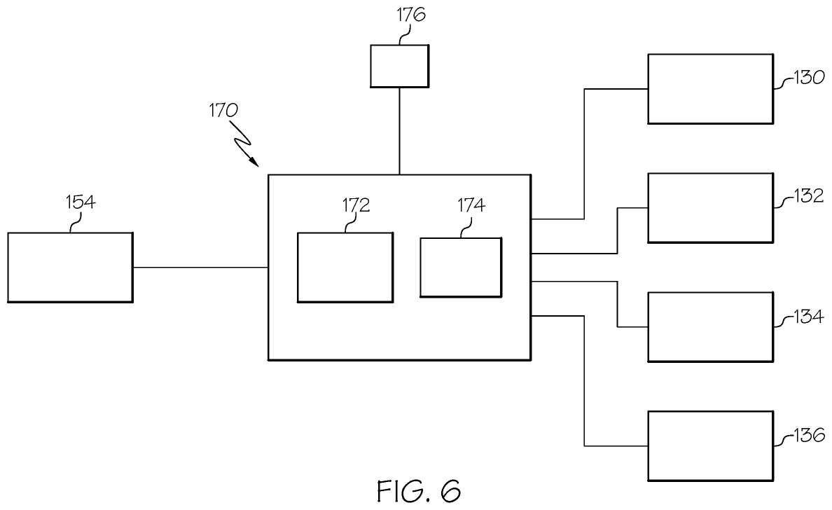

Referring now to FIGS. 3 and 6, in embodiments, the glass separation system 100 may further comprise a controller communicatively coupled to the first A-surface nosing actuator 130, the second A-surface nosing actuator 132, the first B-surface nosing actuator 134, the second B-surface nosing actuator 136, and the scoring actuator 154. The controller 170 may comprise a processor 172 and a non-transitory memory 174 storing computer readable and executable instructions which, when executed by the processor 172, adjusts a spacing between the A-surface nosing bar 102 and the B-surface nosing bar 112 and adjusts a relative orientation of the A-surface nosing bar and the B-surface nosing bar by sending control signals to the first A-surface nosing actuator 130, the second A-surface nosing actuator 132, the first B-surface nosing actuator 134, and the second B-surface nosing actuator 136. The computer readable and executable instructions may also facilitate forming a scoring line in a glass ribbon by sending control signals to the scoring actuator 154 which adjust a position of the scoring head 152 relative to the anvil nosing 122 of the B-surface nosing bar 112 and traverse the scoring head 152 along the rail 156 transverse to the conveyance direction 306 of the glass conveyance pathway 300.

In embodiments, the control signals sent to the first A-surface nosing actuator 130, the second A-surface nosing actuator 132, the first B-surface nosing actuator 134, the second B-surface nosing actuator 136, and the scoring actuator 154 may be initiated by an input device 176 communicatively coupled to the controller 170, as schematically depicted in FIG. 6. For example, in embodiments the input device may be a keyboard, graphical user interface (GUI) such as a touch screen, a mouse, a joystick, or the like. Alternatively, the input device 176 may be a sensor, such as an optical sensor positioned proximate the glass conveyance pathway 300 and configured to detect a position and/or orientation of a continuous glass ribbon relative to the glass conveyance pathway 300. For example, when the input device 176 is a sensor, the sensor may provide a signal to the controller 170 indicative of the position of the continuous glass ribbon. Based on the position of the continuous glass ribbon, the controller 170 may output control signals to the first A-surface nosing actuator 130, the second A-surface nosing actuator 132, the first B-surface nosing actuator 134, and the second B-surface nosing actuator 136 to adjust a position and/or orientation of the A-surface nosing bar and/or the B-surface nosing bar.

Referring now to FIG. 5, an embodiment of an actuator, such as the first A-surface nosing actuator 130, the second A-surface nosing actuator 132, the first B-surface nosing actuator 134, and the second B-surface nosing actuator 136, is schematically depicted. In the embodiments described herein, the positioning and repositioning of the A-surface nosing bar 102 and the B-surface nosing bar 112 is controlled by controlling the actuation stroke length L_{A} of the actuator 130, 132, 134, 136. As depicted in FIG. 5, the actuator 130, 132, 134, 136 has a maximum total stroke length L_{TS}. However, the actuation stroke length L_{A} may be less than the total stroke length L_{TS}. For example, for a given repositioning operation, the actuator may start from a nominal or starting stroke length L_{S}. From the starting stroke length L_{S}, the actuator may be advanced to a second position length L₂. Thus the actuation stroke length L_{A} is the difference between the second position length L₂ and the starting stroke length L_{S}. In embodiments where the starting stroke length L_{S} is 0, L_{A}=L₂.

Referring again to FIGS. 3 and 4, the glass separation system 100 may have a variety of modes of operation including, without limitation, a clamping mode and an adjustment mode. In the clamping mode, the A-surface nosing bar 102 and the B-surface nosing bar 112 are advanced toward one another and the glass conveyance pathway 300 such that a continuous glass ribbon 204 conveyed in the conveyance direction 306 of the glass conveyance pathway 300 is impinged between the A-surface nosing member 104 of the A-surface nosing bar 102 and the B-surface nosing member 114 of the B-surface nosing bar 112. In the clamping mode the actuation direction of the first A-surface nosing actuator 130 and the actuation direction of the second A-surface nosing actuator 132 are opposite the actuation direction of the first B-surface nosing actuator 134 and the actuation direction of the second B-surface nosing actuator 136. That is, the actuation direction of the first and second A-surface nosing actuators 130, 132 may be in the +X direction of the coordinate axes depicted in the figures while the actuation direction of the first and second B-surface nosing actuators 134, 136 may be in the −X direction. In some embodiments of the clamping mode, the actuation stroke length of the first A-surface nosing actuator 130 and the actuation stroke length of the second A-surface nosing actuator 132 may be substantially the same or even the same. Similarly, the actuation stroke length of the first B-surface nosing actuator 134 and the actuation stroke length of the second B-surface nosing actuator 136 may be substantially the same or the same. In some other embodiments of the clamping mode, the actuation stroke length of the first A-surface nosing actuator 130 and the actuation stroke length of the second A-surface nosing actuator 132 may be different. Similarly, the actuation stroke length of the first B-surface nosing actuator 134 and the actuation stroke length of the second B-surface nosing actuator 136 may be different.

In some embodiments of the clamping mode, the actuation stroke length of the first A-surface nosing actuator 130 and the actuation stroke length of the second A-surface nosing actuator 132 are independent of the actuation stroke length of the first B-surface nosing actuator 134 and the actuation stroke length of the second B-surface nosing actuator 136. That is, the actuators may be independently and individually operated such that the stroke length of a particular actuator may be varied from the remaining actuators. For example, and without limitation, the actuation stroke length of the first A-surface nosing actuator 130 and the actuation stroke length of the second A-surface nosing actuator 132 may be different than the actuation stroke length of the first B-surface nosing actuator 134 and the actuation stroke length of the second B-surface nosing actuator 136 In these embodiments, the actuation speed of the first A-surface nosing actuator 130 and the actuation speed of the second A-surface nosing actuator 132 are different than the actuation speed of the first B-surface nosing actuator 134 and the actuation speed of the second B-surface nosing actuator 136 such that the A-surface nosing member 104 of the A-surface nosing bar 102 and the B-surface nosing member 114 of the B-surface nosing bar 112 contact the continuous glass ribbon 204 at substantially the same time. For example, if the actuation stroke length of the first A-surface nosing actuator 130 and the actuation stroke length of the second A-surface nosing actuator 132 are longer than the actuation stroke length of the first B-surface nosing actuator 134 and the actuation stroke length of the second B-surface nosing actuator 136, then the actuation speed of the first A-surface nosing actuator 130 and the actuation speed of the second A-surface nosing actuator 132 may be greater than the actuation speed of the first B-surface nosing actuator 134 and the actuation speed of the second B-surface nosing actuator 136 such that the A-surface nosing member 104 of the A-surface nosing bar 102 and the B-surface nosing member 114 of the B-surface nosing bar 112 contact the continuous glass ribbon 204 at substantially the same time.

Referring now to FIGS. 2A-3, the adjustment mode of the glass separation system 100 may be used to adjust the orientation of the A-surface nosing bar 102 and the orientation of the B-surface nosing bar 112 relative to one another and to the glass conveyance pathway 300 by pivoting the A-surface nosing bar 102 and the B-surface nosing bar 112 about respective A-surface and B-surface axes of rotation 108, 118. In particular, the adjustment mode of the glass separation system 100 may be used to adjust the orientation of the A-surface nosing bar 102 and the orientation of the B-surface nosing bar 112 such that the A-surface nosing bar 102 and the B-surface nosing bar 112 are parallel with the surfaces of a continuous glass ribbon drawn 204 drawn in the conveyance direction 306 of the glass conveyance pathway 300. For example, in the adjustment mode, the actuation stroke length of the first A-surface nosing actuator 130 and the actuation stroke length of the second A-surface nosing actuator 132 may be operated independent of one another such that the A-surface nosing bar pivots about the A-surface axis of rotation 108. As another example, in the adjustment mode, the actuation stroke length of the first A-surface nosing actuator 130 and the actuation stroke length of the second A-surface nosing actuator 132 may be different such that the A-surface nosing bar pivots about the A-surface axis of rotation 108. Similarly, in the adjustment mode, the actuation stroke length of the first B-surface nosing bar actuator and the actuation stroke length of the second B-surface nosing bar actuator may be independent of one another such that the B-surface nosing bar pivots about the B-surface axis of rotation 118. Alternatively or additionally, in the adjustment mode, the actuation stroke length of the first B-surface nosing bar actuator and the actuation stroke length of the second B-surface nosing bar actuator may be different such that the B-surface nosing bar pivots about the B-surface axis of rotation 118.

In some embodiments of the adjustment mode, the actuation direction of the first A-surface nosing actuator 130 and the actuation direction of the second A-surface nosing actuator 132 may be different to facilitate adjusting both the angular orientation of the A-surface nosing bar 102 as well as the spacing between the A-surface nosing bar 102 and a continuous glass ribbon 204 drawn in the conveyance direction 306 of the glass conveyance pathway 300. For example, the first A-surface nosing actuator 130 may be actuated in the +X direction of the coordinate axes illustrated in the figures while the second A-surface nosing actuator 132 may be actuated in the −X direction of the coordinate axes illustrated in the figures. Similarly, the actuation direction of the first B-surface nosing actuator 134 and the actuation direction of the second B-surface nosing actuator 136 may be different to facilitate adjusting both the angular orientation of the B-surface nosing bar 112 as well as the spacing between the B-surface nosing bar 112 and a continuous glass ribbon drawn 204 drawn in the conveyance direction 306 of the glass conveyance pathway 300.

In some embodiments of the adjustment mode, an actuation direction of the first A-surface nosing actuator 130 is the same as an actuation direction of the second B-surface nosing actuator 136. Similarly, in this embodiment, an actuation direction of the second A-surface nosing actuator 132 is the same as an actuation direction of the first B-surface nosing actuator 134. In some of these embodiments, the actuation stroke length of the first A-surface nosing actuator 130 is substantially the same as the actuation stroke length of the second B-surface nosing actuator 136. Similarly, the actuation stroke length of the second A-surface nosing actuator 132 is substantially the same as the actuation stroke length of the first B-surface nosing actuator 134. Alternatively, in some of these embodiments of the adjustment mode, the actuation stroke length of the first A-surface nosing actuator 130 is different than the actuation stroke length of the second B-surface nosing actuator 136. Similarly, the actuation stroke length of the second A-surface nosing actuator 132 is different than the actuation stroke length of the first B-surface nosing actuator 134.

Referring now to FIGS. 1, 7, and 8, in operation, a continuous glass ribbon 204 is drawn from the root 239 of the forming vessel 235 and conveyed in the conveyance direction 306 of the glass conveyance pathway 300 with pull roll assembly 240 into the glass separation system 100. As the continuous glass ribbon 204 passes through the glass separation system 100, an adjustment mode of the glass separation system 100 may be used to pivot the A-surface nosing bar 102 and the B-surface nosing bar 112 about the A-surface and B-surface axes of rotation such that the A-surface nosing bar 102 and the B-surface nosing bar 112 are substantially parallel with the surfaces of the continuous glass ribbon 204.

Once the orientation of the A-surface nosing bar 102 and the B-surface nosing bar 112 have been adjusted to correspond with the orientation of the continuous glass ribbon 204, a clamping mode of the glass separation system 100 may be used to apply a clamping force to the continuous glass ribbon 204 prior to separating a discrete glass sheet 205 from the continuous glass ribbon 204. In particular, the A-surface nosing bar 102 and the B-surface nosing bar 112 are advanced towards the continuous glass ribbon 204 until the continuous glass ribbon 204 is clamped between the A-surface nosing member 104 of the A-surface nosing bar 102 and the B-surface nosing member 114 of the B-surface nosing bar 112. The glass separation system 100 travels along the rails 124 in a downward vertical direction at the same speed that the continuous glass ribbon 204 is conveyed in the conveyance direction 306 as the clamping force is applied to the continuous glass ribbon 204.

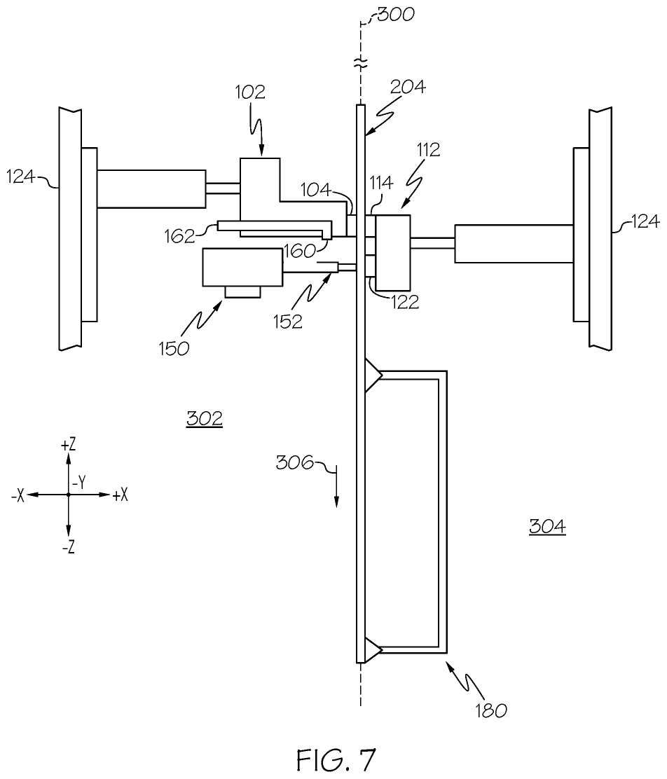

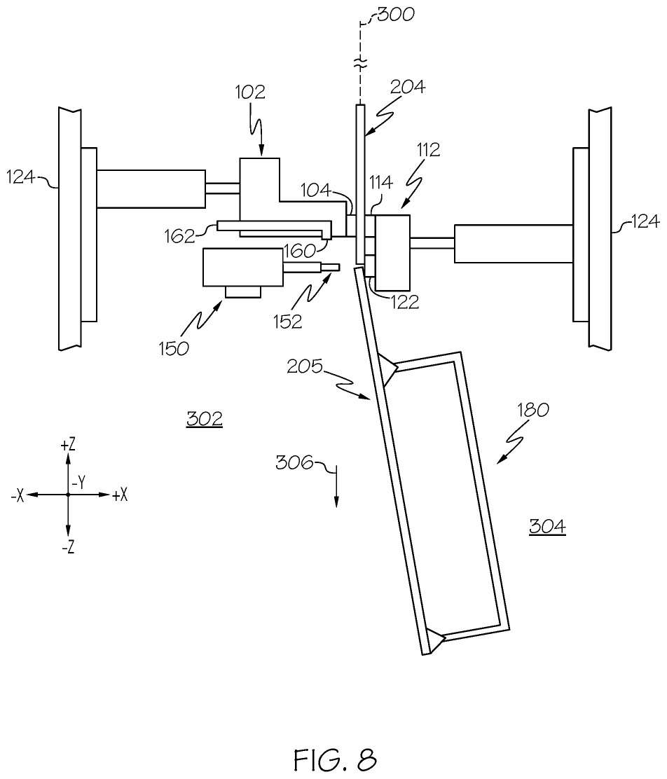

Once the clamping force is applied to the continuous glass ribbon 204, as depicted in FIG. 7, the scoring head 152 of the scoring apparatus 150 is advanced towards the continuous glass ribbon 204 and the continuous glass ribbon 204 is impinged between the scoring head 152 and the anvil nosing 122 of the B-surface nosing bar 112. The scoring head 152 is then traversed across the continuous glass ribbon 204 in a direction transverse to the conveyance direction 306, thereby forming a score line in the continuous glass ribbon 204. During the scoring operation and subsequent separation operation, a negative pressure is applied to the vacuum line 162 such that any glass particulates or other debris from the scoring operation and/or subsequent separation operation are drawn into the vacuum port 160 and evacuated from the glass separation system 100.

Prior to, contemporaneous with, or after the continuous glass ribbon 204 is scored, a glass carriage 180 is attached to the B-surface of the continuous glass ribbon 204 downstream of the glass separation system 100. The glass carriage 180 may be maneuvered into place with a robotic arm (not depicted) and attached to the continuous glass ribbon 204, with, for example, suction cups. Once the continuous glass ribbon 204 has been scored, the glass carriage 180 is maneuvered with the robotic arm to apply a bending moment to the continuous glass ribbon 204 about the score line, thereby separating a glass sheet 205 from the continuous glass ribbon 204. After the glass sheet 205 is separated from the continuous glass ribbon 204, the A-surface nosing bar 102 and the B-surface nosing bar 112 are withdrawn from the continuous glass ribbon 204, thereby disengaging the A-surface nosing member 104 of the A-surface nosing bar 102 and the B-surface nosing member 114 of the B-surface nosing bar 112 from the continuous glass ribbon 204.

Based on the foregoing, it should now be understood that the glass separation systems described herein may be used to compensate for variations in the orientation of a continuous glass ribbon relative to a glass conveyance pathway and conveyance direction, thereby mitigating the risk of damage to the continuous glass ribbon. In particular, the glass separation systems described herein include A and B-surface nosing bars which may be pivoted about an axis of rotation such that the A and B-surface nosing bars are substantially parallel with the surfaces of the continuous glass ribbon, thereby compensating for variations in the orientation of the continuous glass ribbon with respect to the glass conveyance pathway.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A glass separation system for separating a glass substrate from a continuous glass ribbon, the glass separation system comprising:
an A-surface nosing bar positioned on a first side of a glass conveyance pathway, wherein:
a long axis of the A-surface nosing bar is substantially orthogonal to a conveyance direction of the glass conveyance pathway; and
the A-surface nosing bar is pivotable about an axis of rotation parallel to the conveyance direction of the glass conveyance pathway; and
a B-surface nosing bar positioned on a second side of the glass conveyance pathway and opposite the A-surface nosing bar, wherein:
a long axis of the B-surface nosing bar is substantially orthogonal to the conveyance direction of the glass conveyance pathway; and
the B-surface nosing bar is pivotable about an axis of rotation parallel to the conveyance direction of the glass conveyance pathway.

2. The glass separation system of claim 1, further comprising:
a first A-surface nosing actuator coupled to a first end of the A-surface nosing bar and a second A-surface nosing actuator coupled to a second end of the A-surface nosing bar;
a first B-surface nosing actuator coupled to a first end of the B-surface nosing bar and a second B-surface nosing actuator coupled to a second end of the B-surface nosing bar, wherein:
the first end of the A-surface nosing bar is opposite the first end of the B-surface nosing bar and the second end of the A-surface nosing bar is opposite the second end of the B-surface nosing bar; and
the glass separation system comprises an adjustment mode wherein an actuation stroke length of the first A-surface nosing actuator and an actuation stroke length of the second A-surface nosing actuator are independent of one another and an actuation stroke length of the first B-surface nosing actuator and an actuation stroke length of the second B-surface nosing actuator are independent of one another.

3. The glass separation system of claim 2, wherein, in the adjustment mode:
an actuation direction of the first A-surface nosing actuator and the actuation direction of the second A-surface nosing actuator are different; and
the actuation direction of the first B-surface nosing actuator and the actuation direction of the second B-surface nosing actuator are different.

4. The glass separation system of claim 2, wherein, in the adjustment mode:
an actuation direction of the first A-surface nosing actuator is the same as an actuation direction of the second B-surface nosing actuator.

5. The glass separation system of claim 4, wherein, in the adjustment mode:
the actuation stroke length of the first A-surface nosing actuator is substantially the same as the actuation stroke length of the second B-surface nosing actuator.

6. The glass separation system of claim 4, wherein, in the adjustment mode:
an actuation direction of the second A-surface nosing actuator is the same as an actuation direction of the first B-surface nosing actuator.

7. The glass separation system of claim 6, wherein, in the adjustment mode:
the actuation stroke length of the second A-surface nosing actuator is substantially the same as the actuation stroke length of the first B-surface nosing actuator.

8. The glass separation system of claim 2, further comprising a clamping mode wherein:
an actuation direction of the first A-surface nosing actuator and an actuation direction of the second A-surface nosing actuator are opposite an actuation direction of the first B-surface nosing actuator and an actuation direction of the second B-surface nosing actuator.

9. The glass separation system of claim 8, wherein, in the clamping mode, the actuation stroke length of the first A-surface nosing actuator and the actuation stroke length of the second A-surface nosing actuator are substantially the same; and
the actuation stroke length of the first B-surface nosing actuator and the actuation stroke length of the second B-surface nosing actuator are substantially the same.

10. The glass separation system of claim 8, wherein, in the clamping mode:
the actuation stroke length of the first A-surface nosing actuator and the actuation stroke length of the second A-surface nosing actuator are independent of the actuation stroke length of the first B-surface nosing actuator and the actuation stroke length of the second B-surface nosing actuator; and
an actuation speed of the first A-surface nosing actuator and an actuation speed of the second A-surface nosing actuator are independent of an actuation speed of the first B-surface nosing actuator and an actuation speed of the second B-surface nosing actuator.

11. The glass separation system of claim 1, wherein:
the A-surface nosing bar comprises an A-surface nosing member; and
the B-surface nosing bar comprises a B-surface nosing member opposed to the A-surface nosing member and an anvil nosing positioned downstream of the B-surface nosing member, wherein the glass conveyance pathway is positioned between the A-surface nosing member and the B-surface nosing member.

12. The glass separation system of claim 11 further comprising a scoring apparatus positioned on a first side of the glass conveyance pathway and opposite the anvil nosing of the B-surface nosing bar, wherein the scoring apparatus is positioned on a rail extending transverse to the glass conveyance pathway and comprises a scoring actuator for traversing the scoring apparatus along the rail.

13. The glass separation system of claim 12, wherein the scoring apparatus comprises a scoring wheel or a scribing point.

14. The glass separation system of claim 12, wherein the A-surface nosing bar comprises at least one vacuum port, wherein the at least one vacuum port is positioned downstream of the A-surface nosing member and upstream of the scoring apparatus.

15. An apparatus for forming a glass substrate from a glass ribbon, the apparatus comprising:
a forming vessel comprising a first forming surface and a second forming surface converging at a root;
a glass conveyance pathway extending from the root in a downward vertical direction;
a glass separation system positioned downstream of the forming vessel and comprising:
an A-surface nosing bar positioned on a first side of the glass conveyance pathway, the A-surface nosing bar comprising a first A-surface nosing actuator coupled to a first end of the A-surface nosing bar and a second A-surface nosing actuator coupled to a second end of the A-surface nosing bar;
a B-surface nosing bar positioned on a second side of the glass conveyance pathway and opposite the A-surface nosing bar, the B-surface nosing bar comprising a first B-surface nosing actuator coupled to a first end of the B-surface nosing bar, and a second B-surface nosing actuator coupled to a second end of the B-surface nosing bar;
a scoring apparatus positioned on a first side of the glass conveyance pathway downstream from the A-surface nosing bar, wherein:
the first end of the A-surface nosing bar is opposite the first end of the B-surface nosing bar and the second end of the A-surface nosing bar is opposite the second end of the B-surface nosing bar; and
the glass separation system comprises a clamping mode and an adjustment mode wherein, in the adjustment mode, an actuation stroke length of the first A-surface nosing actuator and an actuation stroke length of the second A-surface nosing actuator are independent of one another and an actuation stroke length of the first B-surface nosing actuator and an actuation stroke length of the second B-surface nosing actuator are independent of one another.

16. The apparatus of claim 15, wherein, in the adjustment mode:
an actuation direction of the first A-surface nosing actuator and an actuation direction of the second A-surface nosing actuator are different; and
an actuation direction of the first B-surface nosing actuator and an actuation direction of the second B-surface nosing actuator are different.

17. The apparatus of claim 15, wherein, in the adjustment mode:
an actuation direction of the first A-surface nosing actuator is the same as an actuation direction of the second B-surface nosing actuator.

18. The apparatus of claim 17, wherein, in the adjustment mode:
the actuation stroke length of the first A-surface nosing actuator is substantially the same as the actuation stroke length of the second B-surface nosing actuator.

19. The apparatus of claim 17, wherein, in the adjustment mode:
an actuation direction of the second A-surface nosing actuator is the same as an actuation direction of the first B-surface nosing actuator.

20. The apparatus of claim 19, wherein, in the adjustment mode:
the actuation stroke length of the second A-surface nosing actuator is substantially the same as the actuation stroke length of the first B-surface nosing actuator.

21. The apparatus of claim 15, wherein, in the clamping mode:
an actuation direction of the first A-surface nosing actuator and an actuation direction of the second A-surface nosing actuator are opposite an actuation direction of the first B-surface nosing actuator and an actuation direction of the second B-surface nosing actuator.

22. The apparatus of claim 21, wherein, in the clamping mode, the actuation stroke length of the first A-surface nosing actuator and the actuation stroke length of the second A-surface nosing actuator are substantially the same; and
the actuation stroke length of the first B-surface nosing actuator and the actuation stroke length of the second B-surface nosing actuator are substantially the same.

23. The apparatus of claim 21, wherein, in the clamping mode:
the actuation stroke length of the first A-surface nosing actuator and the actuation stroke length of the second A-surface nosing actuator are independent of the actuation stroke length of the first B-surface nosing actuator and the actuation stroke length of the second B-surface nosing actuator; and
an actuation speed of the first A-surface nosing actuator and an actuation speed of the second A-surface nosing actuator are different than an actuation speed of the first B-surface nosing actuator and an actuation speed of the second B-surface nosing actuator.

24. The apparatus of claim 15, wherein:
the A-surface nosing bar comprises an A-surface nosing; and
the B-surface nosing bar comprises a B-surface nosing opposed to the A-surface nosing and an anvil nosing positioned downstream of the B-surface nosing, wherein the glass conveyance pathway is positioned between the A-surface nosing and the B-surface nosing.

25. The apparatus of claim 15, wherein the A-surface nosing bar comprises at least one vacuum port, wherein an inlet of the at least one vacuum port is positioned upstream of the scoring apparatus.

26. The apparatus of claim 15, wherein the scoring apparatus is positioned on a rail extending transverse to the glass conveyance pathway and comprises a scoring actuator for traversing the scoring apparatus along the rail.

27. A method of separating a glass sheet from a glass ribbon, the method comprising:
conveying a continuous glass ribbon in a conveyance direction on a glass conveyance pathway, wherein the glass conveyance pathway extends through a glass separation system comprising an A-surface nosing bar positioned on a first side of the glass conveyance pathway and a B-surface nosing bar positioned on a second side of the glass conveyance pathway;
pivoting the A-surface nosing bar about an A-surface axis of rotation and the B-surface nosing bar about an B-surface axis of rotation such that, after the pivoting, the A-surface nosing bar and the B-surface nosing bar are parallel with the major surfaces of the continuous glass ribbon;
advancing the A-surface nosing bar and the B-surface nosing bar towards the continuous glass ribbon such that the continuous glass ribbon is clamped between the A-surface nosing bar and the B-surface nosing bar;
forming a score line in the continuous glass ribbon; and
separating a glass sheet from the continuous glass ribbon at the score line.

28. The method of claim 27, wherein the separating comprises applying a bending moment to the continuous glass ribbon about the score line.

29. The method of claim 27, further comprising evacuating glass particulates from the glass separation system during the steps of forming the score line and separating the glass sheet from the continuous glass ribbon at the score line.

30. The method of claim 27, wherein:
the A-surface nosing bar is pivotable about an axis of rotation parallel to the conveyance direction of the glass conveyance pathway; and
the B-surface nosing bar is pivotable about an axis of rotation parallel to the conveyance direction of the glass conveyance pathway.

31. The method of claim 27, wherein the glass separation system further comprises:
a first A-surface nosing actuator coupled to a first end of the A-surface nosing bar and a second A-surface nosing actuator coupled to a second end of the A-surface nosing bar;
a first B-surface nosing actuator coupled to a first end of the B-surface nosing bar and a second B-surface nosing actuator coupled to a second end of the B-surface nosing bar, wherein:
the first end of the A-surface nosing bar is opposite the first end of the B-surface nosing bar and the second end of the A-surface nosing bar is opposite the second end of the B-surface nosing bar; and
the glass separation system comprises an adjustment mode which facilitates the pivoting of the A-surface nosing bar and the B-surface nosing bar wherein, in the adjustment mode, an actuation stroke length of the first A-surface nosing actuator and an actuation stroke length of the second A-surface nosing actuator are independent of one another and an actuation stroke length of the first B-surface nosing actuator and an actuation stroke length of the second B-surface nosing actuator are independent of one another, wherein the adjust mode.

32. The method of claim 31, wherein, in the adjustment mode:
an actuation direction of the first A-surface nosing actuator and the actuation direction of the second A-surface nosing actuator are different; and
the actuation direction of the first B-surface nosing actuator and the actuation direction of the second B-surface nosing actuator are different.

33. The method of claim 31, wherein, in the adjustment mode:
an actuation direction of the first A-surface nosing actuator is the same as an actuation direction of the second B-surface nosing actuator.

34. The method of claim 33, wherein, in the adjustment mode:
the actuation stroke length of the first A-surface nosing actuator is substantially the same as the actuation stroke length of the second B-surface nosing actuator.

35. The method of claim 33, wherein, in the adjustment mode:
an actuation direction of the second A-surface nosing actuator is the same as an actuation direction of the first B-surface nosing actuator.

36. The method of claim 35, wherein, in the adjustment mode:
the actuation stroke length of the second A-surface nosing actuator is substantially the same as the actuation stroke length of the first B-surface nosing actuator.

37. The method of claim 31, further comprising a clamping mode wherein:
an actuation direction of the first A-surface nosing actuator and an actuation direction of the second A-surface nosing actuator are opposite an actuation direction of the first B-surface nosing actuator and an actuation direction of the second B-surface nosing actuator.

38. The method of claim 37, wherein, in the clamping mode, the actuation stroke length of the first A-surface nosing actuator and the actuation stroke length of the second A-surface nosing actuator are substantially the same; and
the actuation stroke length of the first B-surface nosing actuator and the actuation stroke length of the second B-surface nosing actuator are substantially the same.

39. The method of claim 37, wherein, in the clamping mode:
the actuation stroke length of the first A-surface nosing actuator and the actuation stroke length of the second A-surface nosing actuator are independent of the actuation stroke length of the first B-surface nosing actuator and the actuation stroke length of the second B-surface nosing actuator; and
an actuation speed of the first A-surface nosing actuator and an actuation speed of the second A-surface nosing actuator are independent of an actuation speed of the first B-surface nosing actuator and an actuation speed of the second B-surface nosing actuator.
